(19) United States
(12) Patent Application Publication
(10) Pub. No.: US 2014/0172621 A1
(43) Pub. Date: Jun. 19, 2014

(54) SYSTEMS AND METHODS FOR RECOMMENDING PRODUCTS BASED ON A SHOPPING LIST AND A SHOPPING BUDGET

(71) Applicant: WAL-MART STORES, INC., Bentonville, AR (US)

(72) Inventor: Maneesh K. Vittolia, Bloomington, IL (US)

(73) Assignee: WAL-MART STORES, INC., Bentonville, AR (US)

(21) Appl. No.: 13/714,878

(22) Filed: Dec. 14, 2012

(51) Int. Cl. G06Q 30/06

(52) U.S. Cl. CPC G06Q 30/0631
USPC 705/26.7

(57) ABSTRACT

A computer-implemented method for interactive shopping includes storing shopping list data representing items in a shopping list associated with a customer and displaying a user control for selecting a shopping budget associated with the customer. The shopping budget represents a maximum price the customer desires to pay for the items in the shopping list. The computer-implemented method further includes storing budget data representing the shopping budget and generating, from an inventory of products for sale at a retail store, a list of recommended products corresponding to the items in the shopping list based upon the shopping list data and the budget data. A total selling price of the recommended products is within the shopping budget. The computer-implemented method further includes displaying the list of recommended products to a user.

### BACKGROUND

Embodiments of the disclosure relate generally to data processing, and more particularly to systems and methods for generating and/or displaying lists of recommended items for sale based at least in part on an electronic shopping list and a shopping budget.

Increasingly, people are utilizing Internet-based services to perform routine tasks, including shopping. For example, computer-based applications exist for identifying, selecting and purchasing merchandise that is for sale in a traditional retail store, through an electronic commerce (“e-commerce”) website, or both. Such applications may retrieve, via the Internet or other network, data from a merchant for displaying various items that are available for purchase, along with the corresponding selling prices. Customers may use these applications to search or browse for items having particular characteristics, such as model or brand name, product description, size, color, feature set, and/or a variety of other identifying characteristics.

### SUMMARY

According to an embodiment, a computer-implemented method for interactive shopping includes providing a downloadable user interface executable on a mobile electronic device. The user interface is programmed to receive shopping list data representing items in a shopping list associated with a customer and display a user control for selecting a shopping budget associated with the customer. The shopping budget represents a maximum price the customer desires to pay for the items in the shopping list. The user interface is further programmed to display a list of recommended products, selected from an inventory of products, corresponding to the items in the shopping list, with a total selling price of the recommended products being within the maximum price of the shopping budget.

In some embodiments, the user control may be operable to increase or decrease the shopping budget within a predetermined range of prices in response to user manipulation of the user control. In some embodiments, the predetermined range of prices may include a total selling price of a least-expensive set of recommended products corresponding to the items in the shopping list and a total selling price of a most-expensive set of recommended products corresponding to the items in the shopping list.

In some embodiments, the user interface may be further configured to display an updated list of recommended products in response to an increase or decrease in the shopping budget, where the total selling price of the recommended products in the updated list is within the increased or decreased shopping budget. In some embodiments, the updated list may include an automatic substitution of at least one of the recommended products with at least one other product of a same type, from the inventory of products, having a different selling price, sales volume, brand name, quantity, size and/or weight than the substituted product. In some embodiments, the updated list may include a substitution of one or more of the recommended products in the list with at least one other product of a same type, in the inventory of products, having a different selling price than the substituted product. The different selling price may include a coupon savings or discounted amount. In some embodiments, the user interface may be further programmed to display in-store aisle location information associated with at least one of the recommended products.

In some embodiments, the computer-implemented method may further comprise storing, in one or more non-transitory computer-readable storage media, a shopping list data structure for storing the shopping list data. In some embodiments, the computer-implemented method may further comprise storing, in the one or more non-transitory computer-readable storage media, a shopping budget data structure for storing budget data representing the shopping budget.

According to an embodiment, a computer-implemented method for interactive shopping includes storing, by a processor and in a non-transitory computer-readable storage medium, shopping list data representing items in a shopping list associated with a customer. The computer-implemented method further includes displaying, using a user interface operatively coupled to the processor, a user control for selecting a shopping budget associated with the customer. The shopping budget represents a maximum price the customer desires to pay for the items in the shopping list. The computer-implemented method further includes storing, by the processor and in the computer-readable storage medium, budget data representing the shopping budget. The computer-implemented method further includes generating, by the processor and from an inventory of products for sale at a retail store, a list of recommended products corresponding to the items in the shopping list based upon the shopping list data and the budget data. A total selling price of the recommended products is within the shopping budget. The computer-implemented method further includes displaying, using the user interface, the list of recommended products.

In some embodiments, computer-implemented method may further include updating the budget data in response to user manipulation of the user control. The user control may be operable to increase or decrease the shopping budget within a predetermined range of prices. In some embodiments, the predetermined range of prices may include a total selling price of a least-expensive set of recommended products corresponding to the items in the shopping list and a total selling price of a most-expensive set of recommended products corresponding to the items in the shopping list.

In some embodiments, the computer-implemented method may further include updating the list of recommended products subsequent to updating the budget data, such that the total selling price of the recommended products in the updated list is within the increased or decreased shopping budget. In some embodiments, the computer-implemented method may further include displaying, using the user interface, the updated list of recommended products. In some embodiments, the updated list of recommended products may include a substitution of at least one of the recommended products with at least one other product of a same type, in the inventory of products, having a different selling price, sales volume, brand name, quantity, size and/or weight than the substituted product. In some embodiments, the updated list of recommended products may include a substitution of at least one of the recommended products in the list with at least one other item of a same type, in the inventory of products, having a different selling price than the substituted product. The different selling price may include a coupon or discounted amount.

In some embodiments, the computer-implemented method may further include displaying, using the user interface, in-store aisle location information associated with at least one of the recommended products.

According to an embodiment, an interactive shopping system includes a processor, and a memory operatively coupled to the processor. The processor is configured to be operatively coupled to a network and to receive data from and send data to a mobile electronic device via the data communication network. The memory includes processor-readable instructions that when executed by the processor cause the processor to receive shopping list data representing items in a shopping list associated with a customer and budget data representing a shopping budget, store the shopping list data and the budget data in the memory, display, using a user interface of the mobile electronic device, a user control for selecting a shopping budget associated with the customer, the shopping budget representing a maximum price the customer desires to pay for all of the items in the shopping list, store budget data representing the shopping budget, generate, from an inventory of products for sale at a retail store, a list of recommended products corresponding to the items in the shopping list based upon the shopping list data and the budget data, the list of recommended products being based on a type of item identified in the shopping list and the shopping budget, and display, using the user interface, the list of recommended products. A total selling price of the recommended products is within the maximum price of the shopping budget.

In some embodiments, the memory may further include instructions that when executed by the processor cause the server to update the budget data in response to user manipulation of the user control. The user control may be operable to increase or decrease the shopping budget within a predetermined range of prices. In some embodiments, the user control may include a virtual slider control. In some embodiments, the predetermined range of prices may include a total selling price of a least-expensive set of recommended products corresponding to the items in the shopping list and a total selling price of a most-expensive set of recommended products corresponding to the items in the shopping list.

In some embodiments, the memory may further include instructions that when executed by the processor cause the server to update the list of recommended products subsequent to updating the budget data, such that the total selling price of the recommended products in the updated list is within the increased or decreased shopping budget. In some embodiments, the memory may further include instructions that when executed by the processor cause the server to display, using the user interface, the updated list of recommended products. In some embodiments, the updated list of recommended products may include a substitution of at least one of the recommended products with at least one other product of a same type, in the inventory of products, having a different selling price, sales volume, brand name, quantity, size and/or weight than the substituted product. In some embodiments, the updated list of recommended products may include a substitution of at least one of the recommended products in the list with at least one other item of a same type, in the inventory of products, having a different selling price than the substituted product. The different selling price may include a coupon or discounted amount.

In some embodiments, the memory may further include instructions that when executed by the processor cause the server to display, using the user interface, in-store aisle location information associated with at least one of the recommended products.

According to an embodiment, a non-transitory computer-readable medium has stored thereon computer-executable instructions that when executed by a computer cause the computer to store, in one or more databases, shopping list data representing items in a shopping list associated with the customer and display, using a user interface, a user control for selecting a shopping budget associated with the customer. The shopping budget represents a maximum price the customer desires to pay for all of the items in the shopping list. The non-transitory computer-readable medium has further stored thereon computer-executable instructions that when executed by a computer cause the computer to store, in the one or more databases, budget data representing the shopping budget and generate, from an inventory of products for sale at a retail store stored in the one or more databases, a list of recommended products corresponding to the items in the shopping list based upon the shopping list data and the budget data. A total selling price of the recommended products is within the maximum price of the shopping budget. The non-transitory computer-readable medium has further stored thereon computer-executable instructions that when executed by a computer cause the computer to and display, using the user interface, the list of recommended products.

In some embodiments, the non-transitory computer-readable medium may further have instructions that when executed by the computer cause the computer to update the budget data in response to user manipulation of the user control. The user control may be operable to increase or decrease the shopping budget within a predetermined range of prices. The non-transitory computer-readable medium may further have stored thereon computer-executable instructions that when executed by a computer cause the computer to update the list of recommended products such that the total selling price of the recommended products in the updated list is within the increased or decreased shopping budget.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram representing an example of a system for automatically generating product recommendations in accordance with some embodiments;

FIG. 2 depicts an example of a user interface in accordance with some embodiments;

FIG. 3 depicts an example of a user interface in accordance with some embodiments;

FIG. 4 is a flow diagram of a computer-implemented process for recommending items in accordance with some embodiments;

FIG. 5 is a block diagram of an example of a system for carrying out one or more embodiments; and

FIG. 6 is a block diagram of an exemplary client-server environment for implementing one or more embodiments.

### DETAILED DESCRIPTION

According to various embodiments, a computer-implemented method and system are disclosed for automatically generating recommendations for one or more products based on items in an electronic shopping list of a user, products in a store inventory, prices of the recommended products, and a spending budget of the user, also referred to herein as a shopping budget. The recommended products correspond to the items in the electronic shopping list and have a total price that is within the specified shopping budget. In some embodiments, the user may interactively adjust the spending budget using a graphical user interface (GUI) element that allows the user to increase or decrease the budget. As the spending budget is adjusted, the product recommendations can automatically change to reflect the change in budget. For example, if the budget is decreased, similar but lower-priced products may be recommended and displayed to the user.

Online-based technologies have enabled people to use the Internet for shopping. For example, a customer may use the Internet to locate and obtain the price and availability of merchandise sold by a particular retailer, such as groceries, household goods, tools, electronics, toys, clothing, garden supplies, books, movies, music, etc. Such information may be used to build an electronic shopping list that the customer can carry into a store (e.g., on a mobile computing device).

One limitation of some electronic shopping list applications is that they do not automatically take into account the customer's spending budget. If the application does not account for the customer's spending budget, the customer must make mental choices about which items can be purchased within their budget, or use other means for determining which products can be purchased within the budget. For instance, the customer may reach his or her budgeted spending limit before all of the items on the shopping list that the customer wishes to purchase have been accounted for. This may occur if some of the items on the customer's shopping list are more expensive than other similar items that the customer could instead purchase from the merchant. As an example, if the customer has a name brand tube of toothpaste in his or her shopping list, that product may be more expensive than a generic, unbranded tube of toothpaste. If the customer notices this price difference while shopping, he or she may be inclined to purchase the unbranded toothpaste instead of the name brand toothpaste to save some money and help keep expenses within budget. However, this process requires the customer to manually perform additional research and/or calculations, which is inefficient and inconvenient. As a consequence, the customer may not end up purchasing the optimum combination of products within his or her spending budget.

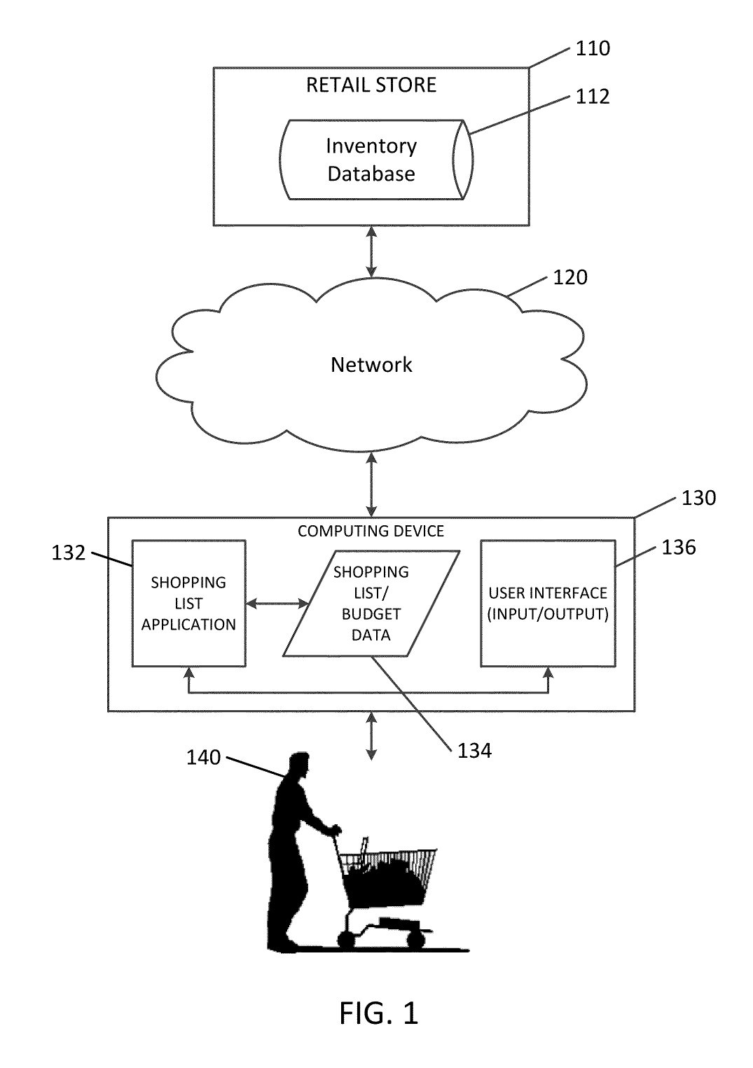

FIG. 1 is a block diagram representing an example of a system for automatically generating product recommendations according to a desired shopping budget. A retail store 110 stocks an inventory of items, which is tracked in an inventory database 112. A network 120, which may include, for example, the Internet, provides a connection for exchanging data between the inventory database 112 and a computing device 130. The computing device 130 may include a computer, mobile computing device, or other computing device having a processor configured to execute a shopping list application 132. The computing device 130 may include a memory configured to store shopping list and budget data 134 (e.g., as one or more data structures), and a user interface 136 operatively connected to the processor executing the shopping list application 132. The user interface 136 may include a GUI for receiving user inputs and displaying information, such as a shopping list and/or a list of recommended items, as well as user controls and other GUI elements. A shopper 140, also referred to herein as a user, interacts with the shopping list application 132 using the computing device 130.

The computing device 130 and the retail store 110 can be interconnected to share and exchange data through the network 120, which may include servers, databases, routers, switches, intranets, the Internet, and other computing and networking components and resources. Network link(s) between the computer device 130 and the inventory database 112 may include any arrangement of interconnected networks including both wired and wireless networks. For example, a wireless communication network link over which the computing device 130 communicates may utilize a cellular-based communication infrastructure that includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, the network links may include wireless technologies including WLAN, WiFi®, WiMAX, Wide Area Networks (WANs), and Bluetooth®. At least a portion of user data, including the shopping list/budget data 134, can be stored in one or more databases connected to, or incorporated within, the network 120, such that the user data may be accessed directly or indirectly from various computing resources, such as the computing device 130 and/or the inventory database 112.

The computing device 130 may include any computing device, such as a personal computer (PC) or a mobile computing device (e.g., smart phone, tablet computer, or personal digital assistant) that is configured to connect directly or indirectly to the network 120 and/or the inventory database 112. Examples of user devices include a smartphone (e.g., the iPhone® manufactured by Apple Inc. of Cupertino, Calif., BlackBerry® manufactured by Research in Motion (RIM) of Waterloo, Ontario, any device using the Android® operating system by Google, Inc. of Mountain View, Calif., or any device using the Windows Mobile® operating system by Microsoft Corp. of Redmond, Wash.), a personal digital assistant, or other multimedia device, such as the iPad® manufactured by Apple Inc. In another example, the computing device 130 may be included in a touchscreen in-store kiosk, which may enable a user to create a shopping list and view a list of recommended products based on items in the shopping list. The computing device 130 may connect to other components (e.g., network 120 and/or the inventory database 112) over a wireless network, such as provided by any suitable cellular carrier or network service provider (e.g., Sprint PCS, T-Mobile, Verizon, AT&T, etc.), or via a WiFi® connection to a data communication network. In one embodiment, the computing device 130 is a mobile computing device provided by the retail store for use while shopping, as opposed to a device owned by the customer. Such a device may be a conventional mobile device (e.g., an iPhone® or iPad®).

The inventory database 112 includes data representing the items for sale in the retail store 110. The data may include, for example, product names, identification numbers (e.g., item numbers, universal product codes, etc.), and prices and/or quantities associated with each item in inventory. The data may also include product classification information. For example, several different types, sizes and/or brands of milk (e.g., Brand A milk, Brand B milk, 1 quart milk, 1 gallon milk, etc.) may each be classified as “milk” or other classifier, which is stored in the inventory database 112. In some embodiments, the inventory database 112, or another database, includes sale or discount price information for one or more products in the inventory database 112. For example, coupon or instant savings amounts corresponding to certain products may be stored in the inventory database 112.

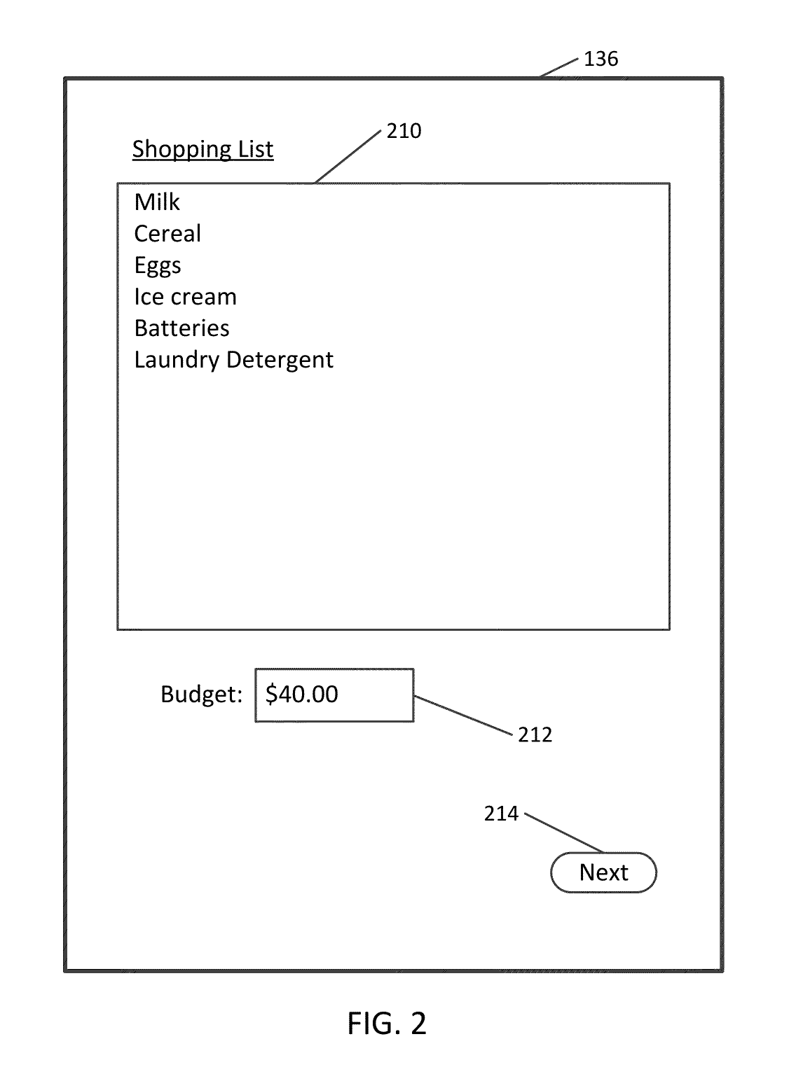

FIG. 2 depicts an example of the graphical user interface 136 of FIG. 1 that may be used in conjunction with the computing device 130, according to one embodiment. The user interface 136 can be configured and/or programmed to provide a shopping list 210 containing one or more items as input by the user 140. For example, the shopping list 210 may include milk, cereal, eggs, ice cream, batteries, and laundry detergent. Items in the shopping list 210 may, for example, be entered, modified and/or removed by the user 140 using GUI elements of the user interface 136, and/or stored in the shopping list/budget data 134. The user interface 200 can further be configured and/or programmed to provide a shopping budget 212 as input by the user 140, which represents a maximum price the user 140 desires or is willing to pay for all of the items in the shopping list 210. The shopping list 210 and the shopping budget may each be stored in the shopping list/budget data 134. The user interface 136 may further include a control button 214 for activating other features of the shopping list application 132, such as described below.

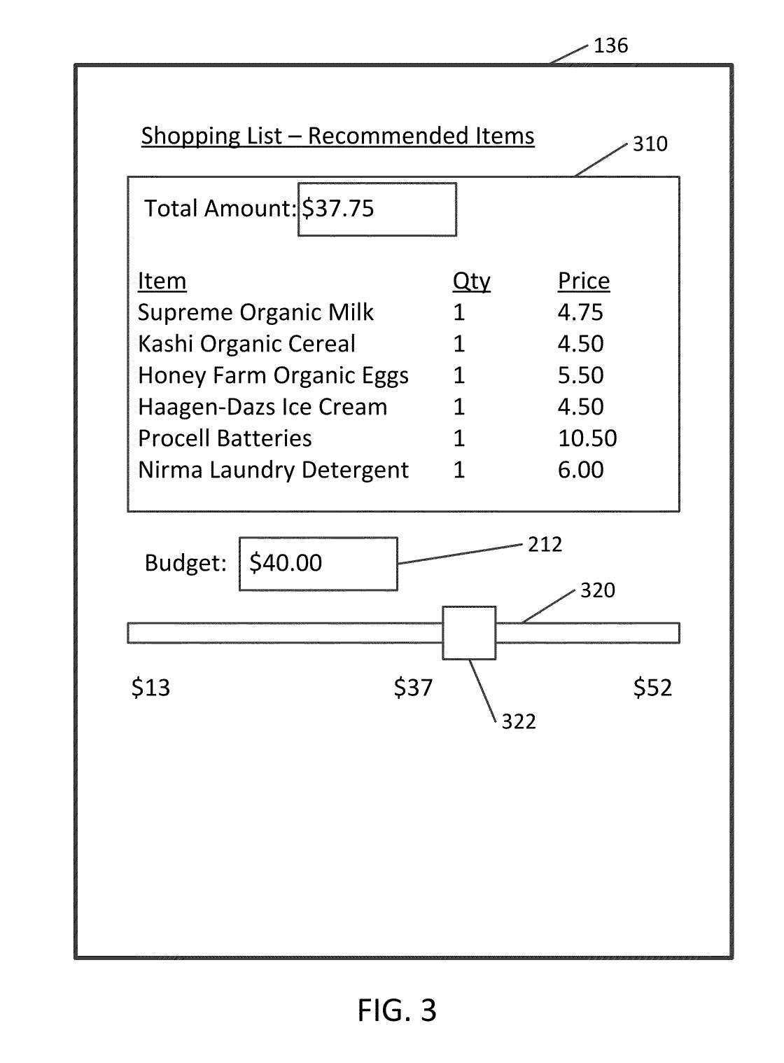

In some embodiments, if the user 140 presses the control button 214, the shopping list application 132 displays, via the user interface 200, a list of recommended items 310 having a total price that is within the shopping budget 212 of the user 140, as depicted in FIG. 3. The list of recommended items 310 is generated by the shopping list application 132 based on the data stored in the inventory database 112, and may include specific items in the store inventory that match the items in the shopping list 210. For example, if milk is one item in the shopping list 210, the list of recommended items 310 may include Supreme Organic Milk, which is one product in the store inventory that has the same classification as the item in the shopping list 210 (e.g., “milk”). The list of recommended items 310 further includes a quantity and price of each recommended item, and the total price of all of the recommended items 310. While the total price may not exceed the shopping budget 212, it may be less than the shopping budget 212. In some embodiments, the total price may reflect sale or discount (e.g., coupon or instant savings) prices for one or more of the recommended items 310.

FIG. 3 also depicts a user control element 320 that is configured to allow the user 140, via the user interface 200, to increase or decrease the shopping budget 212, for example, using a slider 322 or other type of user control. At various intervals, the user control element 320 indicates the minimum and maximum total prices for all of the items in the shopping list 210, and may include intermediate total prices at relative positions on the user control element 320. In other words, the minimum and maximum total prices reflect the least and most amounts the user 140 can spend on the items in the shopping list 210 with respect to the products in the inventory database 112. This is because, although the items in the shopping list 210 may not change, for any given item in the shopping list 210 there may exist, in the inventory of the retail store 110, a variety of products having different prices. Thus, embodiments disclosed herein advantageously enable the user 140 to make informed choices about which specific products to purchase within the designated shopping budget 212 based on the prices of the recommended products. In some embodiments, the inventory database 112 includes products available for purchase online, such as through an electronic commerce website.

In some embodiments, the slider 322 may be moved along the user control element 320 to select specific values for the shopping budget 212. For example, by moving the slider 322 in one direction, the shopping budget 212 decreases; by moving the slider 322 in the opposite direction, the shopping budget 212 increases. In this manner, the user 140 can change and adjust the shopping budget 212 using a single input action, such as dragging the slider 322 with a pointing device (e.g., a mouse) or using his or her finger, if the user interface 136 includes a touch-receptive input device.

As the shopping budget 212 is adjusted by the user 140, the shopping list application 132 automatically changes the recommended items 310 to correspond with the adjusted shopping budget 212. For example, if the shopping budget 212 increases, the shopping list application 132 updates the list of recommended items 310 to include one or more products that are more expensive and/or larger in size and/or quantity than the previously recommended products, while keeping the total price of all recommended items within the adjusted shopping budget 212. For instance, if the user 140 increases the shopping budget 212, one or more generic brand items on the list of recommended items 310 may be substituted with similar or equivalent brand name products that are more expensive. In another example, the quantity or size of one or more products on the list of recommended items 310 may be substituted with larger quantities or sizes of the same product or similar products.

In yet another example, if the shopping budget 212 decreases, the shopping list application 132 updates the list of recommended items 310 to include one or more products that are less expensive and/or smaller in size and/or quantity than the previously recommended products, such that the total price of all recommended items remains within the adjusted shopping budget 212. In this manner, the user 140 can view different sets of product recommendations simply by adjusting the shopping budget 212, and see a display of specific products (including size and/or quantity) corresponding to items on the shopping list 210 that can be purchased for a given shopping budget 212 before entering the retail store 110.

In some embodiments, the list of recommended items 310 includes an aisle locator indicating which aisle in the retail store 110 each recommended item 310 can be found. The information for displaying aisle location may, for example, be retrieved by the shopping list application 132 from the inventory database 112 or another database.

In some embodiments, one or more items in the list of recommended items 310 includes items available from sources other than, or instead of, the retail store 110. For example, the list of recommended items 310 may include one or more items available for purchase from an online (e.g., e-commerce) source if those items are less expensive when purchased from the online source than in the retail store 110. The user may elect to purchase one or more of those items online and request that the purchased product(s) be sent to the retail store 110 for delivery to the user.

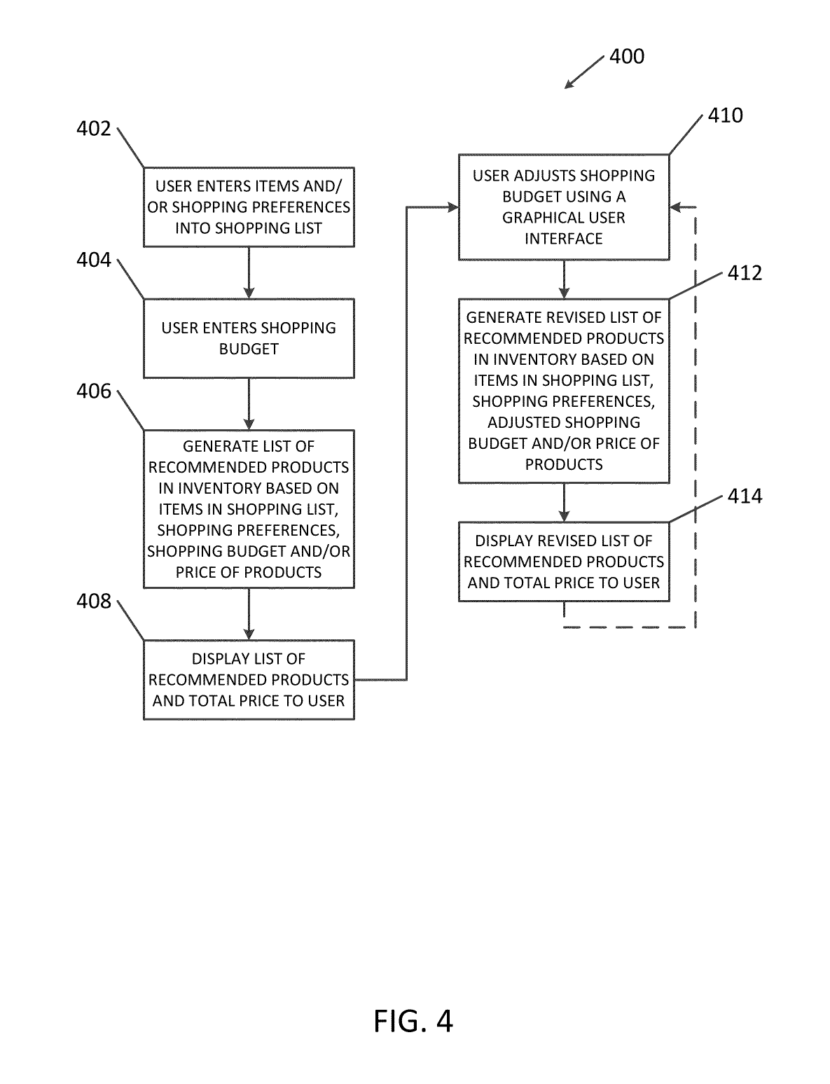

FIG. 4 is a flow diagram of an example of a process 400 for recommending items, according to some embodiments. At step 402, a user enters one or more items and/or shopping preferences into a shopping list, such as the shopping list 210 described above with respect to FIG. 2. The user may enter this information into a computing device (e.g., computing device 130 of FIG. 1) via a user interface (e.g., user interface 136 of FIG. 1) using a keyboard, touch screen or other input device. The items may include any products the user wishes to purchase while shopping at a retail store, such as the retail store 110 described above with respect to FIG. 1.

At step 404, the user enters a shopping budget, e.g., a maximum dollar amount the user desires or is willing to spend on all of the items in the shopping list. At step 406, a list of recommended items products in an inventory of the retail store is generated based on the items in the shopping list, the prices of the products in inventory, and/or the shopping budget. For example, the list of recommended items may be generated by selecting the lowest priced products from the inventory that are similar to the items in the shopping list such that the total price of all selected products is within the shopping budget. If the budget can not be met for all items in the shopping list, in one embodiment, at least one item in the shopping list can be automatically removed such that the budget can be met for the remaining items in the shopping list. The one or more items may, for example, be automatically removed based on the user's purchase history (e.g., the least frequently item may be removed), or based on the price of any recommended product (e.g., remove the fewest number of items to stay within the shopping budget).

In one embodiment, the user may select one or more preferred products (e.g., identified by brand name and/or product name) corresponding to one or more items in the shopping list that the user designates as a preferred product(s). In this instance, the one or more preferred products will be included in the list of recommended items instead of the lowest priced products if the total price of all of the products in the list of recommended items is within the shopping budget. In another embodiment, the preferred products can be determined using historical data, for example, data representing products previously purchased by the user 140. In another embodiment, the list of recommended items may be generated by selecting the highest priced products from the inventory that are similar to the items in the shopping list such that the total price of all selected products is within the shopping budget. At step 408, the list of recommended items is displayed to the user via, for example, the user interface.

In some embodiments, the difference between the lowest priced products and the highest priced products defines a range of prices that the user can spend to purchase all of the products corresponding to the items in the shopping list. At step 410, the user adjusts the shopping budget using, for example, the slider 322 of FIG. 3 to increase or decrease the shopping budget within the range of prices. At step 412, a revised list of recommended products in the inventory is generated based on the items in the shopping list, the prices of the products in inventory, and/or the adjusted shopping budget. For example, the list of recommended items may be generated by selecting one or more lower or higher priced products from the inventory that are similar to the items in the shopping list such that the total price of all selected products is within the adjusted shopping budget. At step 414, the revised list of recommended items is displayed to the user via, for example, the user interface 136. In one embodiment, steps 410, 412 and 414 may be repeated one or more times if, for example, the user wishes to view what effect adjustments to the shopping budget has on the list of recommended items.

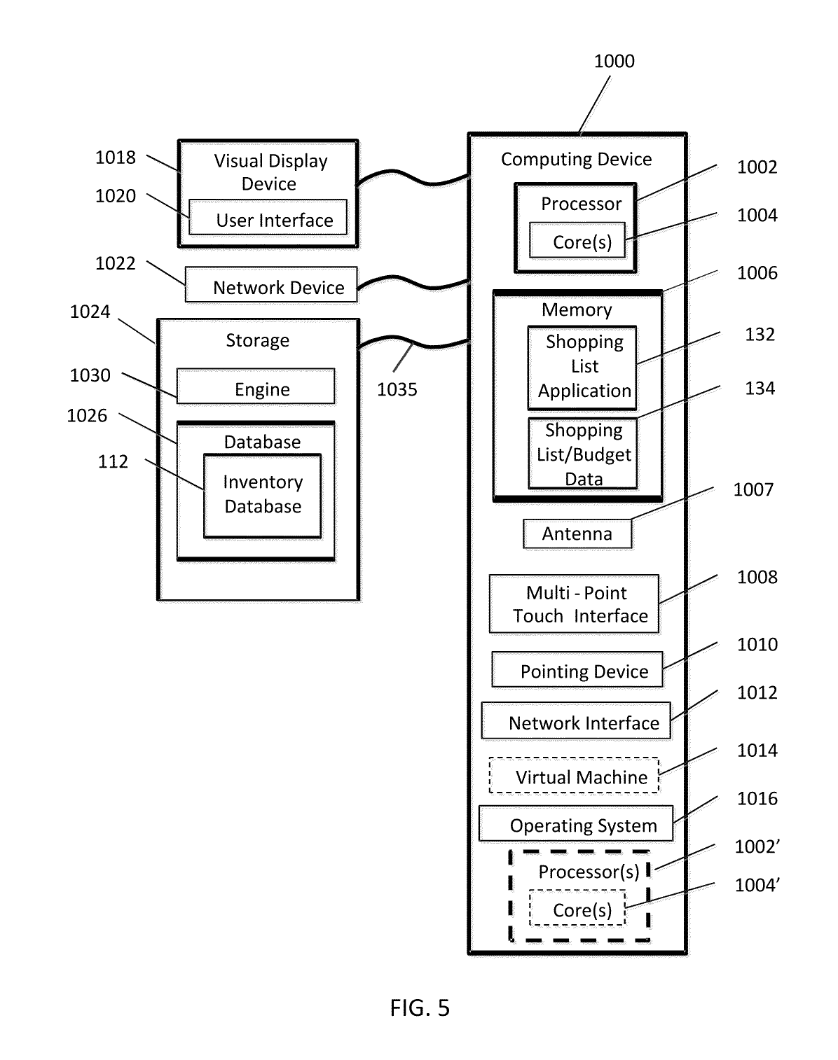

FIG. 5 is a block diagram of an exemplary computing device 1000 that may be used to implement exemplary embodiments described herein. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store non-transitory computer-readable and computer-executable instructions or software for implementing exemplary embodiments, such as process 400 of generating the list of recommended items, the shopping list application 132 and/or the shopping list/budget data 134 of FIG. 1. The computing device 1000 may also include an antenna 1007, e.g., for wireless communication with other computing devices via the network 120 of FIG. 1. The computing device 1000 also includes configurable and/or programmable processor 1002 and associated core 1004, and optionally, one or more additional configurable and/or programmable processor(s) 1002′ and associated core(s) 1004′ (for example, in the case of computer systems having multiple processors/cores), for executing non-transitory computer-readable and computer-executable instructions or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof.

A user may interact with the computing device 1000 through a visual display device 1018, such as a computer monitor or touch screen display integrated into the computing device 1000, which may display one or more user interfaces 1020 (e.g., the user interface 136 of FIG. 1) that may be provided in accordance with exemplary embodiments. The computing device 1000 may include other I/O devices for receiving input from a user, for example, a keyboard or any suitable multi-point touch interface 1008, a pointing device 1010 (e.g., a mouse). The keyboard 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other non-transitory computer-readable media, for storing data and non-transitory computer-readable instructions and/or software that implement exemplary embodiments described herein. The storage devices 1024 may be integrated with the computing device 1000. The computing device 1000 may communicate with the one or more storage devices 1024 via a bus 1035. The bus 1035 may include parallel and/or bit serial connections, and may be wired in either a multi-drop (electrical parallel) or daisy-chain topology, or connected by switched hubs, as in the case of USB. Exemplary storage device 1024 may also store one or more databases 1026 for storing any suitable information required to implement exemplary embodiments. For example, exemplary storage device 1024 can store one or more databases 1026, including the inventory database 112 of FIG. 1, for storing information, such as inventory data, shopping list data, shopping budget data and/or any other information. The storage device 1024 can also store an engine 1030 including logic and programming for receiving the user input parameters and outputting one or more recommended items based on the input parameters, for performing one or more of the exemplary methods disclosed herein.

The computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

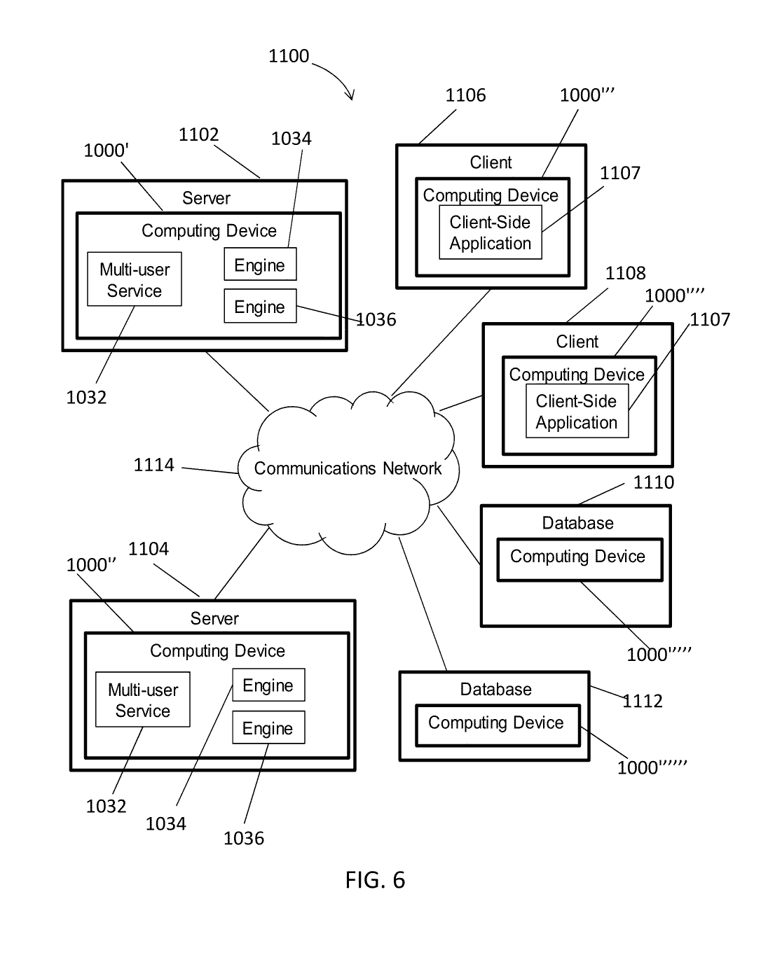

FIG. 6 is a block diagram of an exemplary network environment 1100 suitable for a distributed implementation of exemplary embodiments. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000′ and 1000″, respectively, that are similar to the computing device 1000 illustrated in FIG. 5. The clients 1106 and 1108 may take the form of or include one or more computing devices 1000′″ and 1000″″, respectively, that are similar to the computing device 1000 illustrated in FIG. 5. For example, clients 1106 and 1108 may include mobile user devices. Similarly, the databases 1110 and 1112 may take the form of or include one or more computing devices 1000′″″ and 1000″″″, respectively, that are similar to the computing device 1000 illustrated in FIG. 5. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of client 1106 and/or 1108 to access and interact with a multi-user service 1032 installed on the servers 1102 and/or 1104. For example, the users of client 1106 and/or 1108 may include users associated with an authorized user group and authorized to access and interact with the multi-user service 1032. In some embodiments, the servers 1102 and 1104 may provide client 1106 and/or 1108 with the client-side applications 1107 under a particular condition, such as a license or use agreement. In some embodiments, client 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for a multi-user service. One example of a client-side application is a web browser that allows a user to navigate to one or more web pages hosted by the server 1102 and/or the server 1104, which may provide access to the multi-user service. Another example of a client-side application is a mobile application (e.g., a smart phone or tablet application, such as the shopping list application 132 of FIG. 1) that can be installed on client 1106 and/or 1108 and can be configured and/or programmed to access a multi-user service implemented by the server 1102 and/or 1104.

The databases 1110 and 1112 can store user information, inventory data and/or any other information suitable for use by the multi-user service 1032. The servers 1102 and 1104 can be programmed to generate queries for the databases 1110 and 1112 and to receive responses to the queries, which may include information stored by the databases 1110 and 1112.

Having thus described several exemplary embodiments of the disclosure, it is to be appreciated various alterations, modifications, and improvements will readily occur to those skilled in the art. For example, some embodiments can be applied to inventories of grocery items or other saleable items. Accordingly, the foregoing description and drawings are by way of example only.

What is claimed is:

1. A computer-implemented method for interactive shopping, the method comprising:
providing a downloadable user interface executable on a mobile electronic device, the user interface being programmed to:
receive shopping list data representing items in a shopping list associated with a customer;
display a user control for selecting a shopping budget associated with the customer, the shopping budget representing a maximum price the customer desires to pay for the items in the shopping list; and
display a list of recommended products, selected from an inventory of products, corresponding to the items in the shopping list, with a total selling price of the recommended products being within the maximum price of the shopping budget.

2. The computer-implemented method of claim 1, wherein the user control is operable to increase or decrease the shopping budget within a predetermined range of prices in response to user manipulation of the user control.

3. The computer-implemented method of claim 2, wherein the predetermined range of prices includes a total selling price of a least-expensive set of recommended products corresponding to the items in the shopping list and a total selling price of a most-expensive set of recommended products corresponding to the items in the shopping list.

4. The computer-implemented method of claim 2, wherein the user interface is further configured to display an updated list of recommended products in response to an increase or decrease in the shopping budget, wherein the total selling price of the recommended products in the updated list is within the increased or decreased shopping budget.

5. The computer-implemented method of claim 4, wherein the updated list includes an automatic substitution of at least one of the recommended products with at least one other product of a same type, from the inventory of products, having a different selling price, sales volume, brand name, quantity, size and/or weight than the substituted product.

6. The computer-implemented method of claim 4, wherein the updated list includes a substitution of at least one of the recommended products in the list with at least one other product of a same type, in the inventory of products, having a different selling price than the substituted product, the different selling price including a coupon savings or discounted amount.

7. The computer-implemented method of claim 1, wherein the user interface is further programmed to display in-store aisle location information associated with at least one of the recommended products.

8. The computer-implemented method of claim 1, further comprising storing, in one or more non-transitory computer-readable storage media, a shopping list data structure for storing the shopping list data.

9. The computer-implemented method of claim 1, further comprising storing, in the one or more non-transitory computer-readable storage media, a shopping budget data structure for storing budget data representing the shopping budget.

10. A computer-implemented method for interactive shopping, the method comprising:
storing, by a processor and in a non-transitory computer-readable storage medium, shopping list data representing items in a shopping list associated with a customer;
displaying, using a user interface operatively coupled to the processor, a user control for selecting a shopping budget associated with the customer, the shopping budget representing a maximum price the customer desires to pay for the items in the shopping list;
storing, by the processor and in the computer-readable storage medium, budget data representing the shopping budget;
generating, by the processor and from an inventory of products for sale at a retail store, a list of recommended products corresponding to the items in the shopping list based upon the shopping list data and the budget data, a total selling price of the recommended products being within the shopping budget; and
displaying, using the user interface, the list of recommended products.

11. The computer-implemented method of claim 10, further comprising updating the budget data in response to user manipulation of the user control, the user control being operable to increase or decrease the shopping budget within a predetermined range of prices.

12. The computer-implemented method of claim 11, wherein the predetermined range of prices includes a total selling price of a least-expensive set of recommended products corresponding to the items in the shopping list and a total selling price of a most-expensive set of recommended products corresponding to the items in the shopping list.

13. The computer-implemented method of claim 11, further comprising updating the list of recommended products subsequent to updating the budget data, such that the total selling price of the recommended products in the updated list is within the increased or decreased shopping budget.

14. The computer-implemented method of claim 13, further comprising displaying, using the user interface, the updated list of recommended products.

15. The computer-implemented method of claim 13, wherein the updated list of recommended products includes a substitution of at least one of the recommended products with at least one other product of a same type, in the inventory of products, having a different selling price, sales volume, brand name, quantity, size and/or weight than the substituted product.

16. The computer-implemented method of claim 13, wherein the updated list of recommended products includes a substitution of at least one of the recommended products in the list with at least one other item of a same type, in the inventory of products, having a different selling price than the substituted product, the different selling price including a coupon or discounted amount.

17. The computer-implemented method of claim 10, further comprising displaying, using the user interface, in-store aisle location information associated with at least one of the recommended products.

18. An interactive shopping system comprising:
a processor; and
a memory operatively coupled to the processor,
the processor being configured to be operatively coupled to a network and to receive data from and send data to a mobile electronic device via the data communication network,
wherein the memory includes processor-readable instructions that when executed by the processor cause the processor to:
receive shopping list data representing items in a shopping list associated with a customer and budget data representing a shopping budget;
store the shopping list data and the budget data in the memory;
forwarding for display on a user interface of the mobile electronic device, a user control for selecting a shopping budget associated with the customer, the shopping budget representing a maximum price the customer desires to pay for all of the items in the shopping list;
store budget data representing the shopping budget;
generate, from an inventory of products for sale at a retail store, a list of recommended products corresponding to the items in the shopping list based upon the shopping list data and the budget data, the list of recommended products being based on a type of item identified in the shopping list and the shopping budget, a total selling price of the recommended products being within the maximum price of the shopping budget; and
forwarding for display on the user interface, the list of recommended products.

19. The system of claim 18, wherein the memory further includes instructions that when executed by the processor cause the server to update the budget data in response to user manipulation of the user control, the user control being operable to increase or decrease the shopping budget within a predetermined range of prices.

20. The system of claim 19, wherein the user control includes a virtual slider control.

21. The system of claim 19, wherein the predetermined range of prices includes a total selling price of a least-expensive set of recommended products corresponding to the items in the shopping list and a total selling price of a most-expensive set of recommended products corresponding to the items in the shopping list.

22. The system of claim 21, wherein the memory further includes instructions that when executed by the processor cause the server to update the list of recommended products subsequent to updating the budget data, such that the total selling price of the recommended products in the updated list is within the increased or decreased shopping budget.

23. The system of claim 22, wherein the memory further includes instructions that when executed by the processor cause the server to display, using the user interface, the updated list of recommended products.

24. The system of claim 22, wherein the updated list of recommended products includes a substitution of at least one of the recommended products with at least one other product of a same type, in the inventory of products, having a different selling price, sales volume, brand name, quantity, size and/or weight than the substituted product.

25. The system of claim 22, wherein the updated list of recommended products includes a substitution of at least one of the recommended products in the list with at least one other item of a same type, in the inventory of products, having a different selling price than the substituted product, the different selling price including a coupon or discounted amount.

26. The system of claim 18, wherein the memory further includes instructions that when executed by the processor cause the server to display, using the user interface, in-store aisle location information associated with at least one of the recommended products.

27. A non-transitory computer-readable medium having stored thereon computer-executable instructions that when executed by a computer cause the computer to:
store, in one or more databases, shopping list data representing items in a shopping list associated with the customer;
display, using a user interface, a user control for selecting a shopping budget associated with the customer, the shopping budget representing a maximum price the customer desires to pay for all of the items in the shopping list;
store, in the one or more databases, budget data representing the shopping budget;
generate, from an inventory of products for sale at a retail store stored in the one or more databases, a list of recommended products corresponding to the items in the shopping list based upon the shopping list data and the budget data, a total selling price of the recommended products being within the maximum price of the shopping budget; and
display, using the user interface, the list of recommended products.

28. The non-transitory computer-readable medium of claim 27, further having instructions that when executed by the computer cause the computer to:
update the budget data in response to user manipulation of the user control, the user control being operable to increase or decrease the shopping budget within a predetermined range of prices; and
update the list of recommended products such that the total selling price of the recommended products in the updated list is within the increased or decreased shopping budget.
